(19) United States
(12) Patent Application Publication
(10) Pub. No.: US 2008/0089078 A1
(43) Pub. Date: Apr. 17, 2008

(54) LAMP HOLDER CONSTRUCTION

(76) Inventor: QingBiao Wu, Fujian (CN)

Correspondence Address: PERKINS COIE LLP, POST OFFICE BOX 1208, SEATTLE, WA, 98111-1208, US

(21) Appl. No.: 11/759,198

(22) Filed: Jun. 6, 2007

Related U.S. Application Data
(63) Continuation-in-part of application No. 11/250,632, filed on Oct. 14, 2005, now Pat. No. 7,241,032.

(30) Foreign Application Priority Data
Jun. 7, 2006 (CN) 200620073898.6
Aug. 19, 2005 (CN) 200520074833.9

(51) Int. Cl. F21V 19/00

(52) U.S. Cl. 362/382

(57) ABSTRACT

A lamp includes a lamp cover, a light emitting diode (LED), and a lamp holder. The lamp holder includes at least two insulation parts firmly combined or attached to each other and formed an inner cover, in which a plurality of channels running longitudinally through its internal space provides a passage for the electrical components to pass through. The inner cover is completely inserted into the outer cover. With such configuration, it is easy to assemble and to repair a lamp holder without damaging any of its parts. In addition, an annular groove into which a neck of the lamp cover is mounted is provided, such that any kinds of lamp cover with a suitable neck size can be fitted thereto.

### CROSS-REFERENCE TO RELATED APPLICATIONS

The present application claims priority to Chinese Patent Application No. 200620073898.6, filed Jun. 7, 2006, and is a continuation-in-part application of U.S. patent application Ser. No. 11/250,632, filed Oct. 14, 2005, which claims priority to Chinese Patent Application No. 200520074833.9, filed Aug. 19, 2005. The disclosures of all applications are incorporated by reference herein in their entirety, including drawings.

### FIELD OF THE INVENTION

The present invention relates to a lamp and a lamp holder, more particularly to a lamp including a light emitting diode (LED) as the lighting source, and a lamp holder that is used to securely and safely enclose electrically conductive components.

### BACKGROUND

Lamps with an LED light source typically include a lamp cover, the LED, and a lamp holder. The LED is positioned inside the lamp cover and has two legs extending out of a head of the lamp cover through attached lead wires. The lamp cover head is then put in a machine for injection, forming a lamp holder within which the lamp cover head and the lead wires are tightly enclosed. Producing a lamp in this manner is relatively difficult and complicated. Additionally, if the LED or the lamp cover breaks, a professional tool is generally required to split open the lamp holder and to replace the broken part. The lamp holder must then be injected again.

Electrically conductive components such as lead wires and LED legs are commonly coated with solder and covered with a PVC heat shrink tubing to insulate and protect the components from short circuit. When a PVC heat shrink tubing is used, slide first the PVC heat shrink tubing over the conductive components and apply heat evenly to the tubing until it is shrunk and conforms to the size and shape of the conductive components. The main disadvantage of doing so is that the electrical conductive components are soldered and protected with a PVC heat shrink tubing. Any repair occurred, such as a blown out LED, will need to damage the PVC heat shrink tubing, and removed the LED by heating the solder on it up and flicker it off with an iron., then resoldered a new LED and slided a PVC heat shrink tubing over its legs. In addition, PVC heat shrink tubing cannot be recovered to its initial shape and size after shrinking, therefore, it cannot be reused.

### BRIEF SUMMARY

A lamp including an LED light source is configured such that it is easy to assemble and to repair. The lamp includes a lamp cover, an LED, and a lamp holder. The lamp holder includes an inner cover and an outer cover, with the inner cover including two or more insulating movable parts each having a top portion and a bottom portion. Two longitudinal channels are formed through the top portion and the bottom portion of each of the insulating movable parts in a position adjacent to and isolated relative to each other. Two or more openings or through holes are formed on the top portion and the bottom portion of each of the insulating movable parts.

The LED legs extend through the through holes of the top portion and are held in engagement, in the longitudinal channels, with lead wires projecting in an upward direction through the through holes of the bottom portion. The inner cover with the embedded lead wires is positioned in the outer cover to form an annular groove intermediate to the outer wall surface of the inner cover and the inner wall surface of the outer cover. The lamp cover head is mounted in the annular groove. Both the annular groove and the lamp cover head preferably include spiral threading for engagement with each other.

Each of the movable parts is preferably in the form of a semi-cylindrical body and is provided with four (or a different number of) semicircular holes, with two holes located in the top portion and two holes located in the bottom portion. The internal space of one of the movable parts includes an insulation projection that separates the internal space into two longitudinal channels. A groove extending in a longitudinal direction along the center of the corresponding movable part accommodates the insulation projection. Circular openings or through holes are formed by merging two of the semicircular holes such that each of the through holes is in communication with a longitudinal channel on one of the sides of the insulation projection.

A directive block is provided at the top portion of each of the longitudinal channels. The directive blocks form two narrow slots into which the LED legs enter via the through holes. A pair of directive grooves is formed at corresponding positions on the other movable part for accommodating the insulating directive blocks. An end of each lead wire includes a conductive plate that is held in engagement with an LED leg at the narrow slot.

A pair of convex flanges is formed at the lower end of each of the longitudinal channels. Corresponding convex flanges, central to each pair of convex flanges, are formed at corresponding positions on the other movable part having the insulation projection. Each pair of convex flanges and its corresponding convex flange are positioned in opposed relation to each other in their respective longitudinal channels.

One method of assembling the LED lamp includes positioning each of the conductive plates in the corresponding narrow slots, and combining the two movable parts end-to-end to form an inner cover. The inner cover is then inserted into the outer cover. Next, the LED legs are inserted through the through holes in the top portion of the inner cover. The insulating directive blocks guide each of the LED legs toward a respective narrow slot such that the LED legs make electrical contact with the embedded conductive plates. The lamp cover head is then screwed or otherwise mounted into the annular groove intermediate to the inner cover and the outer cover.

Aside from being relatively easy to assemble, the LED lamp is also relatively easy to repair. If a lamp cover is broken, the lamp cover can be unscrewed from the annular groove and replaced with a new lamp cover. If an LED is broken or otherwise inoperable, the lamp cover can be unscrewed from the annular groove, and the LED can be pulled out of the through holes located at the top portion of the inner cover. A new LED can then be added to replace the bad LED. If a conductive plate has a failure contact with a lead wire or LED leg, the lamp cover can be unscrewed from the annular groove, the outer cover can be removed from the inner cover, and the two movable parts of the inner cover can be loosened. The conductive plate can then be removed so that it can be repaired. All of these repairs are convenient and may be performed without damaging any portion of the LED lamp.

A lamp holder configured as such is easy to assemble and to repair. The lamp holder includes two or more insulation parts combined or attached to form an inner cover. A plurality of channels running through the interior body of the inner cover provides passage for the conductive components to pass through, and the inner cover is completed inserted into the outer cover.

The inner cover is formed by the first insulation part and the second insulation part firmly combined or attached to each other, with the first insulation part comprising a lamp seat, two narrow slots and two longitudinal channels running through its interior body, all preferably made of an insulating material. Two or more through holes are formed and extended downwardly through the lamp seat to make an engagement with the narrow slots and the longitudinal channels. The second insulation part is shaped in such a way to receive the lamp seat, narrow slot and the longitudinal channels of the first insulation part when combined.

An insulation projection is formed at the connection between the lamp seat and the narrow slots to separate the narrow slots and the longitudinal channels individually at the middle into two isolated areas.

A pair of directive blocks having an angle of inclination is formed at the two side of the connection between the lamp seat and the insulation projection, with the directive blocks forming the space in where the lamp seat and the insulation projection connected into two narrow slots.

An LED recipient is formed at the top portion of the first insulation part and of the lamp seat, with its inner diameter exactly fit to hold the LED flange. A positioning flange near to the LED recipient is located at the upper end of the inner wall of the first insulation part that can use to hold the bottom flange of the LED in place, and the second insulation part includes a positioning flange at the corresponding position on its upper end.

An annular groove into which a neck of the lamp cover is mounted is provided at a space between the inner cover and the outer cover. Two or more through holes through which legs on the LED pass is provided in the cylindrical body adjacent to the annular groove.

A positioning pin facing the second insulation part is provided on the lamp seat, and the second insulation part includes a positioning hole at a corresponding position for engagement with the positioning pin of the first insulation part.

The first insulation part and the second insulation part are firmly combined or attached to each other.

Plurality of convex flanges are formed at the lower end of the first insulation part in a horizontal direction, and the second insulation parts includes one or more convex flanges at the corresponding position, too.

One method of assembling the lamp holder includes inserting the conductive plate at an end of each of the lead wires into a narrow slot, allowing each another end of the lead wires to extend out through the lower end of longitudinal channels; then, combining the first insulation part with the second insulation part to form an inner cover which is then inserted into an outer cover, and inserting the legs of the LED simultaneously into the two through holes in the lamp seat. Each of the LED legs will extend out through a through hole and to make an electrical contact with a respective conductive plate at a narrow slot.

The described lamp holder configuration provides several benefits. For example, if an LED is blown out, a repair can be made by pulling the LED legs out of the through holes and replacing it with a new LED. If a conductive plate has a failure contact with LED leg, a repair can be made by pulling the inner cover out of the outer cover and opening the two combined parts. All of these repairs are convenient and may be made without damaging any portion of the lampholder. In addition, an annular groove into which a neck of the lamp cover is mounted is provided, such that any kinds of lamp cover with a suitable neck size can be fitted thereto.

Other features and advantages of the invention will appear hereinafter. The features of the invention described above can be used separately or together, or in various combinations of one or more of them. The invention resides as well in sub-combinations of the features described. Furthermore, many of the method steps described herein may be performed in a different order than that which is explicitly described.

### BRIEF DESCRIPTION OF THE DRAWINGS

FIG. 1 is a fragmentary, sectioned, perspective view of a lamp holder according to embodiment 1.

FIG. 2 is a perspective view of the insulation part 91 illustrated in FIG. 1.

FIG. 3 is an unassembled perspective view of a lamp holder according to embodiment 1

FIG. 4 is an assembled perspective view of a lamp holder according to embodiment 1.

FIG. 5 is a fragmentary, sectioned, perspective view of a lamp holder according to embodiment 2.

FIG. 6 is a perspective view of the insulation part 91 illustrated in FIG. 5.

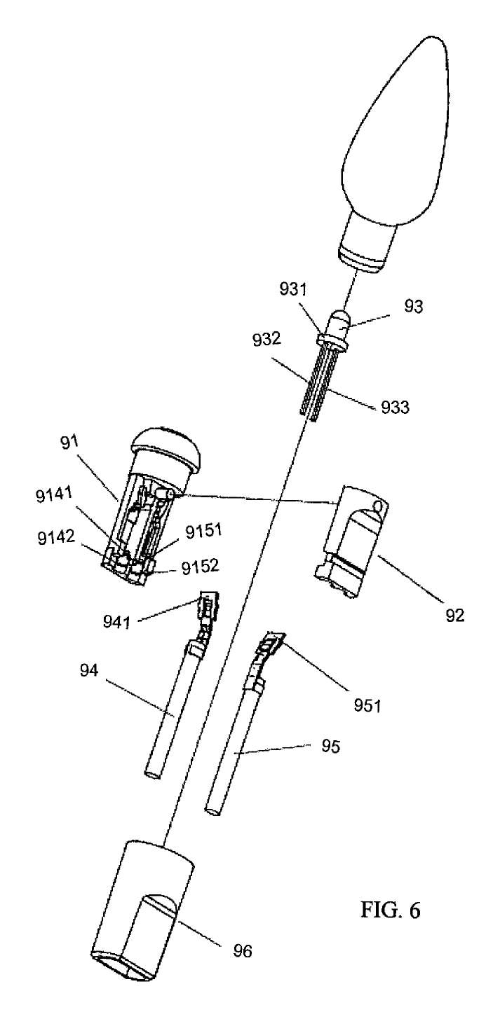

FIG. 7 is an unassembled perspective view of a lamp holder according to embodiment 2.

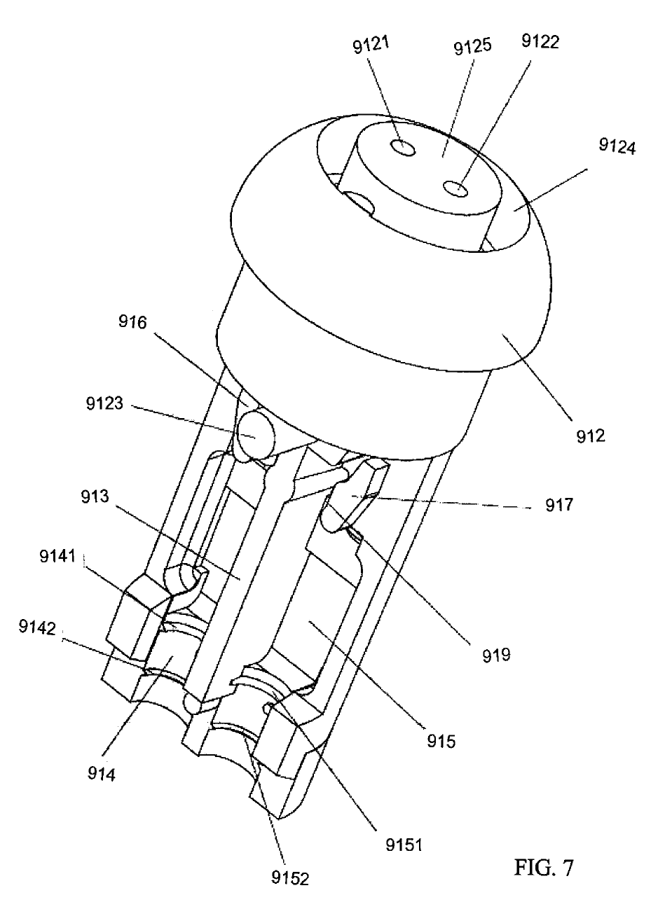

FIG. 8 is an assembled perspective view of a lamp holder according to embodiment 2.

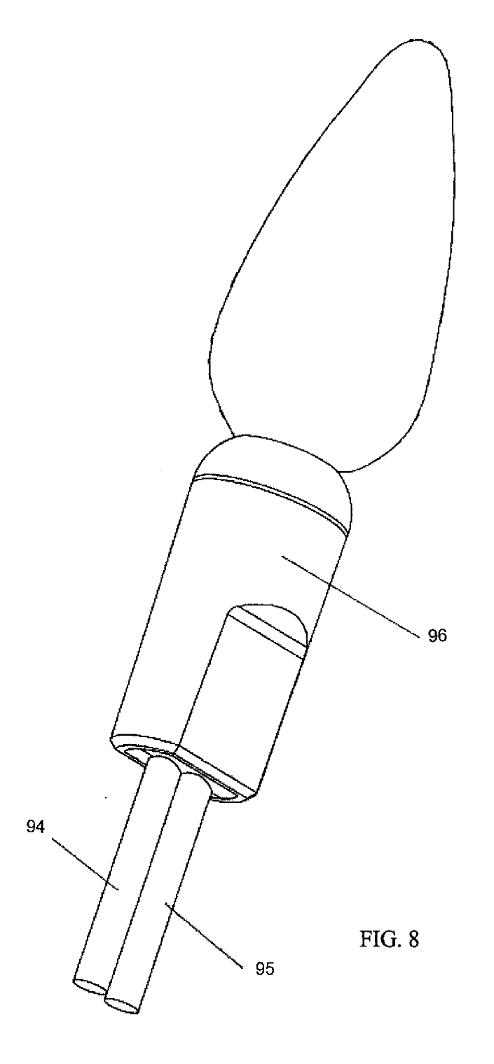

FIG. 9 is a fragmentary, sectioned, perspective view of an LED lamp according to one embodiment.

FIG. 10 is an assembled perspective view of the LED lamp illustrated in FIG. 9.

FIG. 11 is a perspective view of two sections of an inner cover of the LED lamp illustrated in FIG. 9.

### DETAILED DESCRIPTION OF THE INVENTION

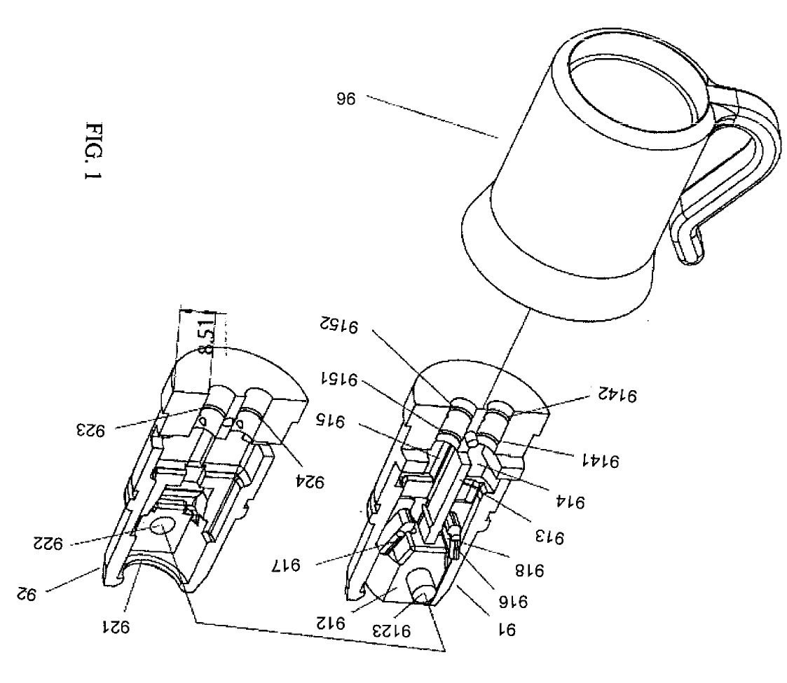

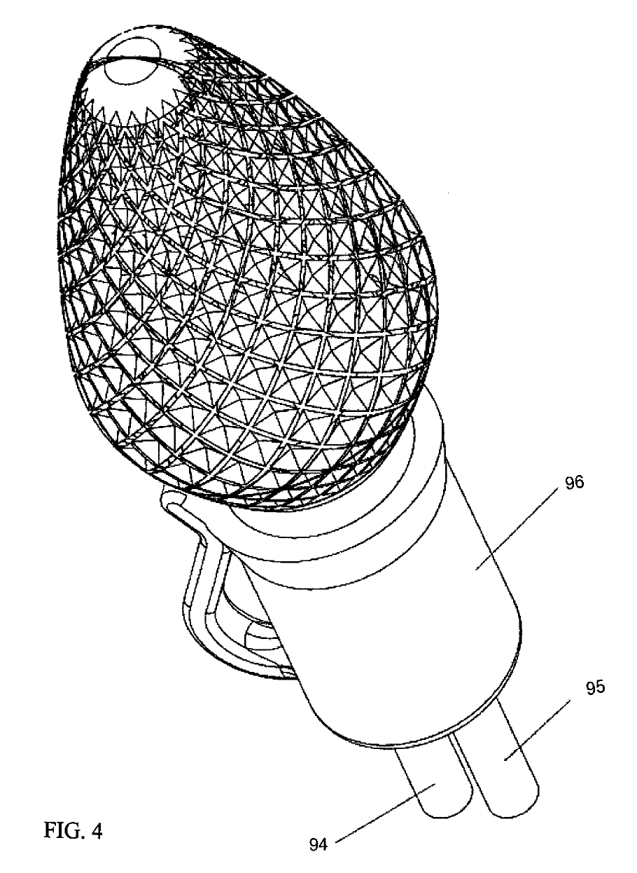

Referring to FIGS. 1 and 4, a lamp holder includes two insulation parts 91 and 92 combined or attached to form an inner cover, and with the inner cover completely inserted into the outer cover 96. A groove and a flange is formed separately at the outer wall of the two insulation parts 91 and 92 and at the inner wall of the outer cover to tightly hold the two insulation parts 91 and 92 within the outer cover 96 when inserted. An annular groove into which a neck of the lamp holder is mounted is formed at an end between the outer cover 96 and the insulation parts.

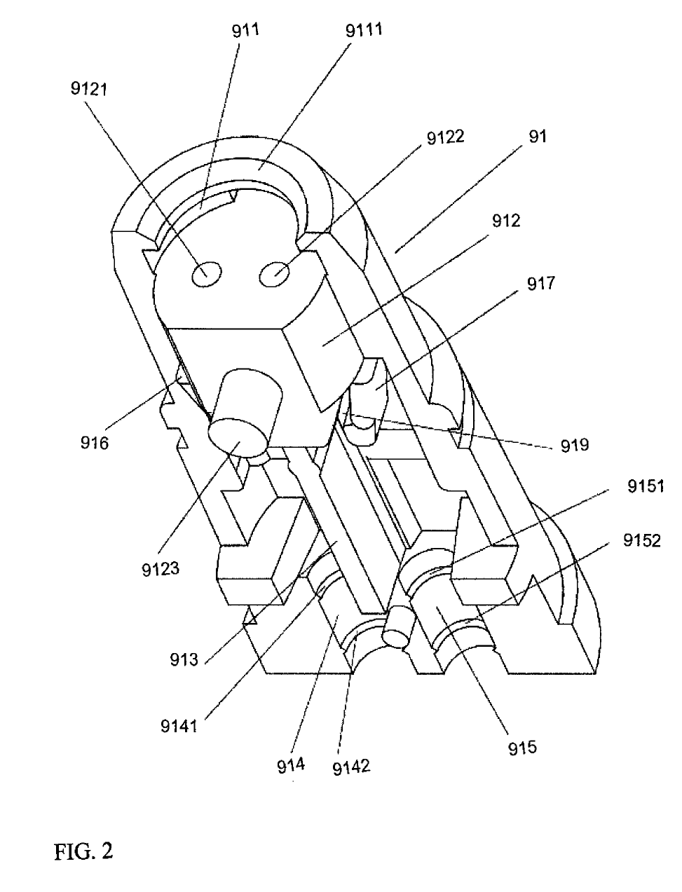

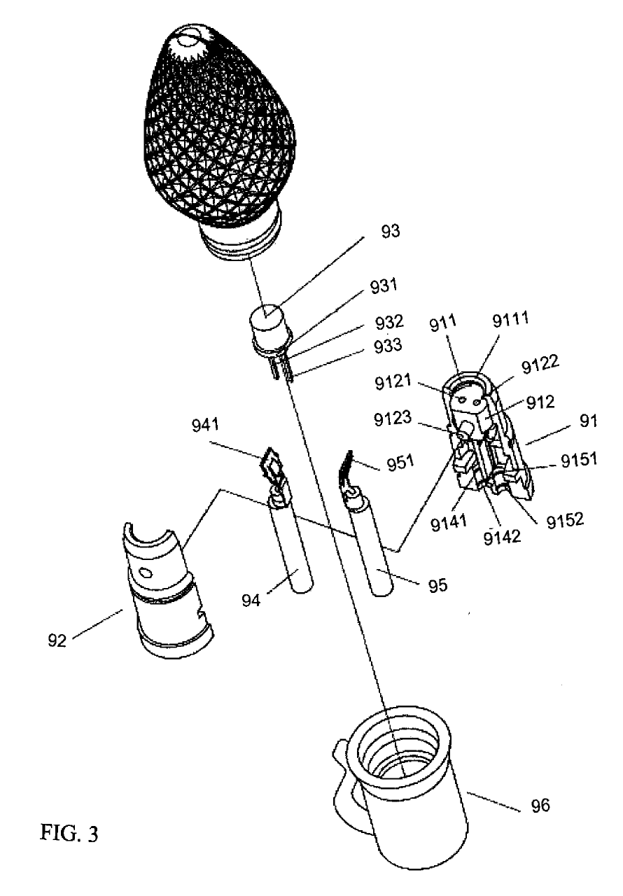

Referring to FIGS. 1, 2, 3, and 4, an LED recipient 911 and a lamp seat 912 are provided at an end of the insulation part 91, with the inner diameter of the LED recipient 911 exactly fit to hold the bottom flange 931 of the LED 3. A positioning flange 9111 near to the LED recipient 911 is located at the upper end of the insulation part 91 that can use to hold the bottom flange 931 of the LED 3 in place. Two through holes 9121, 9122 through which the legs 932, 933 on the LED 3 pass are provided in the lamp seat 912. A positioning pin 9123 is formed at the lamp seat 912 in a position facing the insulation part 92. A insulation projection 913 located at an end of the lamp seat 912 away from the LED recipient 911 is extended through the insulation part 91 and separated its interior body into two longitudinal channels 914, 915. A pair of directive blocks 916, 917 having an angle of inclination is provided at the two sides of the connection between the lamp seat 912 and the insulation projection 913 for shaping the space thereof into two narrow slots 918, 919.

Insulation part 92 is shaped to receive the lamp seat 912, narrow slots 918, 919 and longitudinal channels 914, 915 when combined with the insulation part 91. Positioning flange 921 is formed in the insulation part 92 at its upper end corresponding to the positioning flange 9111. A positioning hole 922 is formed at the insulation part 92 for receiving the insulation pin 9123.

Two pairs of convex flanges 9141, 9142 and 9151, 9152 are formed respectively at the lower end of each of the longitudinal channels 914, 915. Convex flanges 923, 924 are formed in the internal portion of the insulation part 92 with each convex flange corresponding to a central portion located between one of the pairs of the convex flanges 9141, 9142 and 9151, 9152 in one of the longitudinal channels 914, 915. When the two insulation parts 91, 92 are attached or otherwise combined with each other, each pair of convex flanges 9141, 9142 and 9151, 9152 associated with one of convex flanges 923, 924 tightly holds the lead wires 94, 95 within the longitudinal channels 914, 915 to eliminate stress forces between the lead wires 94, 95 and the conductive plates 941, 951. Securing the conductive plates 941, 951 in the longitudinal channels 914, 915 in this manner provides a secure engagement between the conductive plates 941, 951 and the LED legs 931, 932.

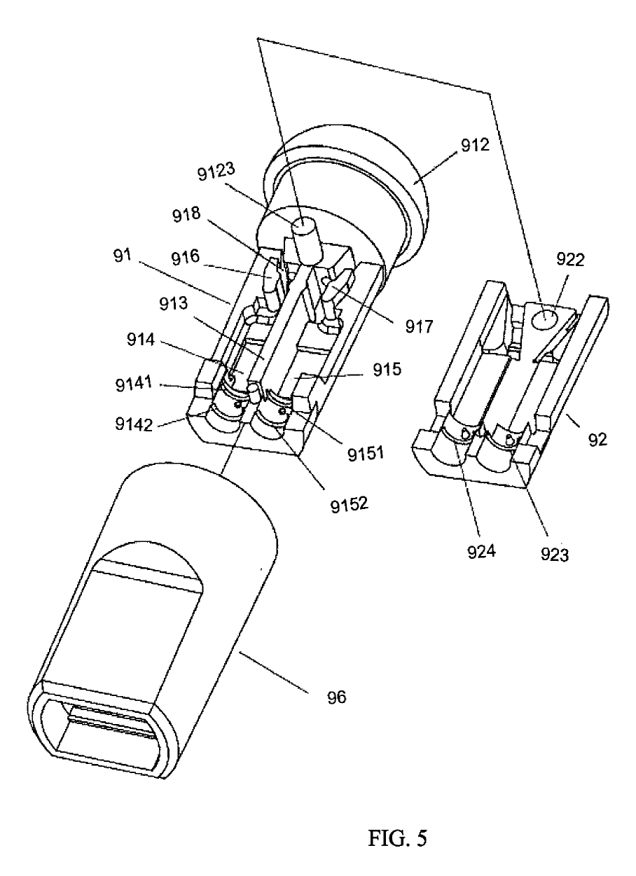

Referring to FIGS. 5,6,7,8 shows another embodiment of the lampholder wherein an annular groove 9124 into which a neck of the lamp cover is mounted is provided at the top portion of the lamp seat 912. Two through holes 9121, 9122 are formed in the cylindrical body 9125 adjacent to the annular groove 9124 to provide openings through which legs on the LED pass.

One method of assembling the lamp holder according to embodiment 92 includes fitting the conductive plates 941, 951 at an end of the lead wires 94, 95 into the narrow slot 918, 919, the flexible plate on each of the conductive plates 941, 951 may position the conductive plates 941, 951 securely inside the narrow slots 918, 919. Lead wires 94, 95 is extended out from the lower end of the insulation part 91 via the longitudinal channels 914, 915. Insulation part 91 and insulation part 92 are then attached to or otherwise combined with each other to form an inner cover. Next, legs 932, 933 on the LED 93 are inserted simultaneously into respective through holes 9121, 9122 of the lamp seat 912 and exit lamp seat 912 for engagement with the corresponding conductive plates 941, 951 at the narrow slots 918, 919. The inner cover is then positioned within the outer cover 96.

The described lamp holder configuration provides several benefits. For example, if an LED is blown out, a repair can be made by pulling the LED legs out of the through holes and replacing it with a new LED. If a conductive plate has a failure contact with LED leg, a repair can be made by pulling the inner cover out of the outer cover and opening the two combined parts. All of these repairs are convenient and may be made without damaging any portion of the lampholder. In addition, an annular groove into which a neck of the lamp cover is mounted is provided, such that any kinds of lamp cover with a suitable neck size can be fitted thereto.

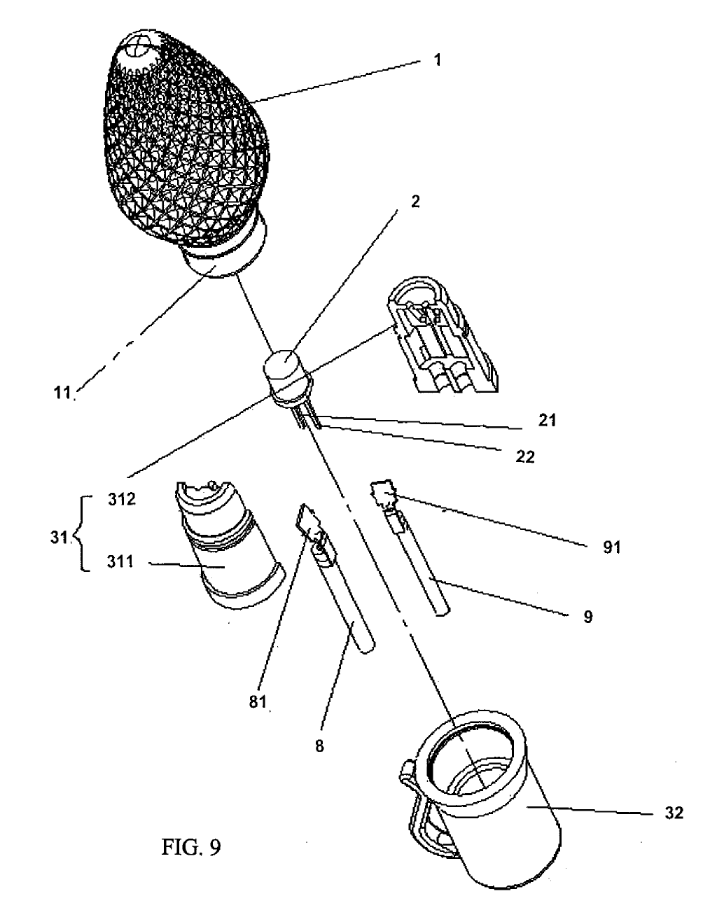

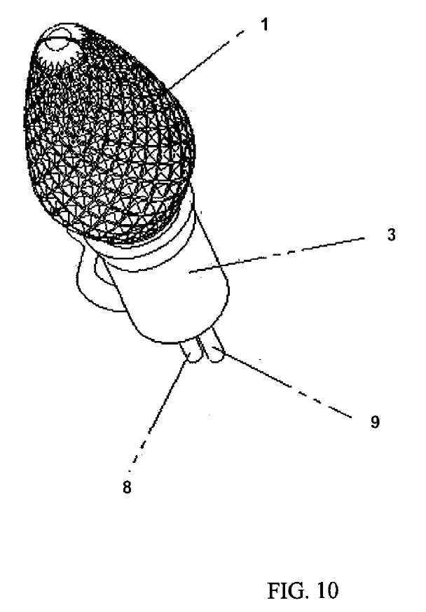

Referring to FIGS. 9 and 10, an LED lamp includes a lamp cover 1, a light emitting diode 2, and a lamp holder 3. The lamp holder 3 includes an inner cover 31 and an outer cover 32.

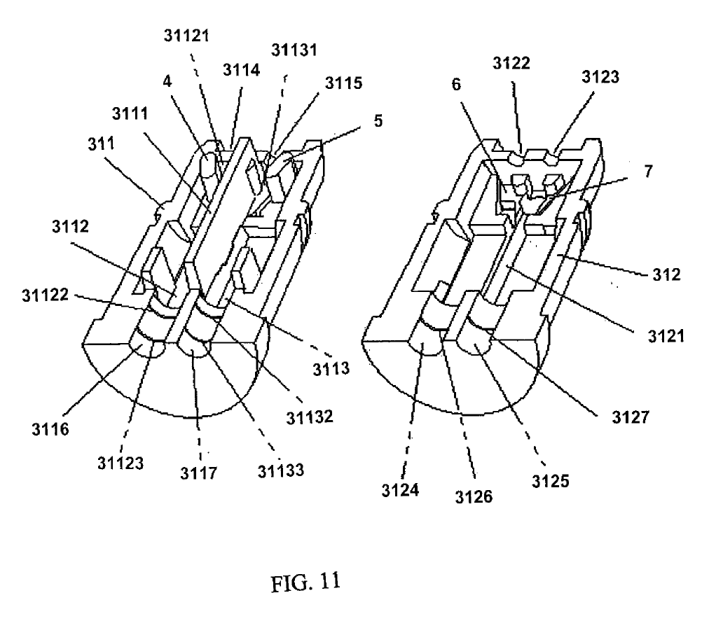

Referring to FIG. 11, the inner cover 31 includes two movable parts 311 and 312, which may each have the form of a semi-cylindrical body having a top portion and a bottom portion. Both the top portion and the bottom portion of each of the movable parts 311 and 312 include two or more semicircular holes 3114, 3115, 3116, 3117 and 3122, 3123, 3124, 3125, respectively.

The internal space of the movable part 311 includes an insulation projection 3111 extending along the centerline of the movable part 311 in a longitudinal direction to form two longitudinal channels 3112, 3113. The internal space of the other movable part 312 is recessed with a groove 3121 for engagement with the insulation projection 3111 of the movable part 311. The movable part 311 and the other movable part 312 are attached or otherwise combined to form the inner cover 31. When the inner cover 31 is formed, four corresponding pairs of the semicircular holes 3114, 3115, 3116, 3117 and 3122, 3123, 3124, 3125 align with each other to form four circular openings or through holes. Two of the openings are located at the upper edge of the inner cover 31, and two of the openings are located at the bottom edge of the inner cover 31. These four through holes are in communication with the longitudinal channels 3112, 3113 at the two sides of the insulation projection 3111.

The ends of the longitudinal channels 3112, 3113 of the movable part 311 include insulating directive blocks 4, 5. The insulating directive blocks 4, 5 shape the space adjacent thereto into two narrow slots 31121, 31131. A pair of directive grooves 6, 7, at an angle of inclination, is located at an end of the other movable part 312 for accommodating the pair of insulating directive blocks 4, 5. Two conductive plates 81, 91, each associated with an end of a lead wire 8, 9, are held in engagement with two legs 21, 22 of the light emitting diode 2 at the narrow slots 31121, 31131. The two legs 21, 22 of the light emitting diode 2 and the lead wires 8, 9 are inserted in downward and upward directions, respectively, into the inner cover 31 via the through holes located in the upper edge and the bottom edge of the inner cover 31.

The longitudinal channels 3112, 3113 each include a pair of convex flanges 31122, 31123 and 31132, 31133 located at a position where the lead wires 8, 9 pass through the longitudinal channels 3112, 3113. The interior of the movable part 312 is provided with convex flanges 3126, 3127 that are located central to the convex flanges 31122, 31123 and the convex flanges 31132, 31133 when the two movable parts 311, 312 are attached to, or otherwise combined with, each other. The convex flanges are used to securely hold the lead wires 8, 9 within the longitudinal channels 311, 312 to eliminate stress between the lead wires 8, 9 and the conductive plates 81, 91. Because the lead wires 8, 9 are secured within the longitudinal channels 311, 312, a secure engagement occurs between the conductive plates 81, 91 of the lead wires 8, 9 and the LED legs 21, 22.

The top portion of the inner cover 31 is configured to fit into the lamp cover head 11, and the bottom portion of the inner cover 31 is configured to insert into the outer cover 32 with its outer surfaces bearing against the inner wall surface of the outer cover 32. The top portion of the inner wall surface of the outer cover 32 is adapted for holding the lamp cover head 11. When inserting the inner cover 31 into the outer cover 32, an annular groove is formed intermediate the outer wall surface of the inner cover 31 and the inner wall surface of the outer cover 32 into which the lamp cover head 11 is mounted. Both the annular groove and the lamp cover head 11 preferably include corresponding spiral threading for engagement with each other.

The outer wall surface of the inner cover 31 preferably includes a protruding convex loop, and the inner wall surface of the outer cover 32 preferably includes a corresponding positioning groove for receiving the convex loop and holding the inner cover 31 firmly in place.

One method of assembling the LED lamp includes positioning the conductive plates 81, 91 of the lead wires into respective narrow slots in the longitudinal channels of the movable part 311 including the insulation projection. The two movable parts 311, 312 are attached or combined end-to-end to form the inner cover 31, and the inner cover is then inserted into the outer cover 32. Next, the LED legs 21, 22 are inserted through the openings or through holes in the top portion of the inner cover 31. The directive blocks 4, 5 guide the LED legs 21, 22 toward the respective narrow slots so that the LED legs 21, 22 make electrical contact with the conductive plates 81, 91. The lamp cover head 11 is then screwed or otherwise mounted onto the annular groove formed intermediate the inner cover and the outer cover.

If the lamp cover is broken it may be unscrewed or otherwise removed from the annular groove and replaced with a new lamp cover. If the LED is broken or otherwise inoperable, the lamp cover may be unscrewed or otherwise removed from the annular groove, and the LED may be pulled out of the through holes located on the top surface of the inner cover. A new LED may then be inserted to replace the bad LED. If a conductive plate has a failure contact with a lead wire or LED leg, the lamp cover may be unscrewed or otherwise removed from the annular groove, the outer cover may be removed from the inner cover, and the two movable parts of the inner cover may be loosened with respect to each other. The conductive plate may then be removed so that it can be repaired. All of these repairs are convenient and may be performed without damaging any portion of the LED lamp.

Thus, while several embodiments have been shown and described, various changes and substitutions may of course be made, without departing from the spirit and scope of the invention. Many of the method steps described herein, for example, may be performed in a different order than that which is specifically described. The invention, therefore, should not be limited, except by the following claims and their equivalents.

What is claimed is:

1. A lamp holder comprising:
a) two or more insulation parts firmly combined or attached to each other and form an inner cover, wherein a plurality of channels running longitudinally through its internal space provides a passage for electrical components to pass through; and
b) an outer cover made of an insulating material into which the inner cover is inserted.

2. The lamp holder according to claim 1 further comprising an annular groove formed between the inner cover and the outer cover into which the neck of a lamp cover is mounted

3. The lamp holder according to claim 1, wherein said two or more insulation parts are combined or attached to each other.

4. The lamp holder according to claim 1, wherein the inner cover includes a first insulation part and a second insulation part,
wherein the first insulating part comprises a lamp seat, a pair of narrow slots and two channels running longitudinally through its internal space, two through holes through which legs on a LED pass having formed in the lamp seat with an end connected to a narrow slot and a longitudinal channel,
wherein the second insulation part is shaped in such a way to receive said lamp seat, said narrow slots and said longitudinal channels of the first insulation part when combined.

5. The lamp holder according to claim 4 further comprising an insulation projection extending from the connection between the lamp seat and the narrow slots to separate the narrow slots and the channels individually into two isolated areas.

6. The lamp holder according to claim 5 further comprising a pairs of directive blocks, inclined in an angle, formed at the two sides where the lamp seat and the insulation projection connected, with the directive blocks shaping a space separated by the insulation projection but adjacent to the lamp seat into a pair of narrow slots.

7. The lamp holder according to claim 4 further comprising an LED recipient at the top of the lamp seat and of the first insulation part, wherein the inner diameter of the LED recipient is exactly fit to hold a bottom flange of the LED, with a positioning flange near to the LED recipient and located at the upper end of the inner wall of the first insulation part used to hold the bottom flange of the LED in place, and with the second insulation part includes a positioning flange at the corresponding position on its upper end.

8. The lamp holder according to claim 4 further comprising two through holes formed in the cylindrical body adjacent to the annular groove.

9. The lamp holder according to claim 4 further comprising a positioning pin, facing the second insulation part, located at the lamp seat, wherein a positioning hole is located at the second insulation part at a corresponding position for engagement with the positioning pin of the first insulation part.

10. The lamp holder according to claim 4 further comprising convex flanges formed horizontally at the lower end of the first insulation part, wherein the second insulation part includes convex flange at the corresponding position.

11. A lamp, comprising:
a lamp cover including a lamp cover head;
an LED including a plurality of legs; and
a lamp holder of claim 1.

12. A lamp, comprising:
a lamp cover including a lamp cover head;
an LED including a plurality of legs; and
a lamp holder, comprising:
an outer cover;
an inner cover, comprising:
a pair of insulating movable parts having a top portion and a bottom portion;
a pair of longitudinal channels formed through the top portion and the bottom portion of the insulating movable parts in a position adjacent to and isolated relative to each other;
a plurality of through holes formed in the top portion and the bottom portion of each of the insulating movable parts;
wherein the LED legs extend through the through holes of the top portion and are held in engagement, in the longitudinal channels, with lead wires extending in an upward direction through the through holes in the bottom portion; and
wherein the inner cover embedded with the lead wires is inserted into the outer cover to form an annular groove intermediate to an outer wall surface of the inner cover and an inner wall surface of the outer cover, with the lamp cover head mounted in the annular groove.

13. The lamp according to claim 12, wherein each of the movable parts is in the form of a semi-cylindrical body having four semicircular holes, with two of the holes located in the top portion, and two of the holes located in the bottom portion, and wherein an insulation projection protrudes from an internal space of one of the movable parts in a longitudinal direction to separate the internal space into the pair of longitudinal channels, and wherein a groove extends along a center of the other movable part in a longitudinal direction to accommodate the insulation projection, with pairs of the semicircular holes combined together to form circular through holes each in communication with one of the longitudinal channels.
